(19) United States
(12) Patent Application Publication
(10) Pub. No.: US 2012/0215691 A1
(43) Pub. Date: Aug. 23, 2012

(54) SYSTEM AND METHOD FOR PAYMENT TRANSFER

(76) Inventors: Yuval Tal, Bronx, NY (US); Yaniv Chechik, Petach Tikav (IL)

(21) Appl. No.: 13/215,249

(22) Filed: Aug. 23, 2011

Related U.S. Application Data
(63) Continuation of application No. 11/905,388, filed on Sep. 28, 2007, now abandoned.
(60) Provisional application No. 60/847,754, filed on Sep. 28, 2006.

(51) Int. Cl. G06Q 20/40

(52) U.S. Cl. 705/44

(57) ABSTRACT

A system and method for payment transfer between a paying party and a recipient party. Optionally and preferably, payment transfer is made by using a prepaid card, which has many security and administrative advantages. Other payment methods may also optionally be used. Also, optionally a plurality of micropayments are provided to a plurality of recipients. The paying party is optionally a media content provider while the recipient party is optionally a user who provides content, although many different combinations of paying/recipient parties may optionally be implemented.

This application claims priority from U.S. patent application Ser. No. 11/905,388, filed on 28 Sep. 2007, which claims priority from U.S. Provisional Application No. 60/847,754, filed on 28 Sep. 2006, all of which are hereby incorporated by reference as if fully set forth herein.

### FIELD OF THE INVENTION

The present invention relates to a system and a method for payment transfer, and in particular, to such a system and method which enables payments to be calculated and distributed to a plurality of users through a plurality of transfer methods.

### BACKGROUND OF THE INVENTION

The Internet has enabled computer users all over the world to interact and communicate electronically. One particularly popular mode for communication is through Web pages, which collectively form the World Wide Web. Web pages are useful for displaying text and graphics, and even animation, video data and audio data. A recent phenomenon which advantageously uses Web pages is for the display and/or distribution of user-generated content, rather than professional content generated by media companies. The use of Web pages and the Internet enables users to upload and display content, such as video content for example, which might not otherwise become publicly available.

One example of a Web site that features such content is from YouTube Inc, available at youtube.com, which has the slogan “broadcast yourself”. YouTube offers amateur (non-professional) video content from a variety of users. Such users have the option to make their content publicly available to everyone, or alternatively only to a selected group (such as family and friends). The popularity of the former type of content has raised the possibility of monetization of the amateur content, with profit sharing between YouTube and the author of the content (user who provided the amateur content). Such monetization could come from advertising revenue obtained as a result of the amateur content being displayed, for example, and/or through paid subscriptions and/or pay-per-view fees, as other examples.

Of course, many other types of media content could be shared through various Web sites or Web display services, and could be similarly monetized. Examples of media content include but are not limited to audio, video, written material (optionally with or without illustrations and/or other types of content), images and mixed content, software, games and the like.

Monetization of all of these different types of content could be performed as described above, through advertising revenue and/or through paid subscriptions and/or pay-per-view fees, as non-limiting examples. However, the potential for profit sharing or otherwise paying fees to the authors of the amateur content could be complicated by the nature of the payments, which would presumably involve a plurality of collected small payments to be distributed to a large number of individuals. Thus, the cost of making the payments could be prohibitively large, as a convenient, inexpensive method for distribution of such small collected payments to a large number of users does not currently exist.

Another non-limiting example of an online business model which could benefit from such a payment method includes Web site owners which pay other owners for linking to their Web pages, optionally when a visitor to a Web page clicks on a link to visit another Web page. Payment may optionally only be made if the visitor also purchases a product through the other Web page and/or performs some type of required action. The amount of payment may be quite small for each such visitor viewing the other Web page (in pennies or even fractions of pennies for US currency for example) but they can provide a source of income for Web site owners.

Other non-limiting examples for the above include business models in which users are paid for any type of Internet activity, which may be activity that occurs through the Internet or activity that occurs off-line, but which preferably has some type of link to the Internet.

Of course, convenient methods to distribute small payments securely would be useful for a wide variety of users. For example, parents of teenagers or college students (or even younger children) may need to give their children money for a variety of daily tasks, such as purchasing lunch, using public transportation, buying snacks or treats, or purchasing books and/or school supplies and/or clothes and/or discretionary items (such as CDs or other forms of music, movies and so forth. However, there are frequently problems with currently available methods of giving children payment instruments, as cash money can be lost or stolen, credit cards may provide too much discretion to children and not enough control by parents, and other types of payment instruments are not typically useful for daily living by children.

Other types of users might want to give money for a variety of reasons, including but not limited to, gift coupons or cards (in which the gift giver provides money to the gift recipient for purchasing a gift); bonuses or prizes in a variety of situations; rewards; reimbursement; various types of remuneration; and so forth. Many of these payments are inconvenient to make through cash, and other payment instruments may be too costly and/or inappropriate. Thus, clearly an improved method for payment transfer is required.

### SUMMARY OF THE INVENTION

There is an unmet need for, and it would be highly useful to have, a system and a method for payment transfer which is convenient and low cost, even for small sums of money.

There is also an unmet need for, and it would be highly useful to have, a system and a method for payment transfer which may optionally provide more control over how and/or when the money is spent or otherwise used.

There is also an unmet need for, and it would be highly useful to have, a system and a method for payment transfer which provides money in a convenient monetary instrument, in which the sum of money is preferably protected from theft or loss.

The present invention is of a system and method for payment transfer between a paying party and a recipient party. Optionally and preferably, payment transfer is made by using a prepaid card, which has many security and administrative advantages. The paying party is optionally a media content provider while the recipient party is optionally a user who provides content, although many different combinations of paying/recipient parties may optionally be implemented.

The present invention is preferably operative online. By “online”, it is meant that communication is performed through an electronic communication medium, including but not limited to, telephone voice communication through the PSTN (public switched telephone network), cellular telephones or a combination thereof; exchanging information through Web pages according to HTTP (HyperText Transfer Protocol) or any other protocol for communication with and through mark-up language documents; exchanging messages through e-mail (electronic mail), messaging services such as ICQ, SMS (Short Message Service) and its variants, including but not limited to EMS (Enhanced Messaging Service), MMS (Multimedia Messaging Service) and the like, for example, and any other type of messaging service; any type of communication using a computational device as previously defined; as well as any other type of communication which incorporates an electronic medium for transmission.

As described herein, the term “micropayment” refers to any payment mechanism for transferring very small amounts of money electronically and/or virtually. The term originally meant a payment as small as 1/1000th of a US dollar, such that the payment mechanism could handle payments at least as small as a tenth of a cent, but also preferably includes payments too small to be affordably processed by credit card or other electronic transaction processing mechanism. All of these definitions are incorporated herein with regard to the term “micropayment” without limitation.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

All websites, documents, books, references and any other material to which reference is made in this application are hereby incorporated by reference as if fully set forth herein.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary, illustrative system for payment transfer according to the present invention;

FIG. 2 is a flowchart of an exemplary, illustrative method for payment transfer according to the present invention;

FIG. 3 is a schematic block diagram of an exemplary, illustrative system for payment transfer to a preferred embodiment of a monetary instrument according to the present invention;

FIG. 4 is a flowchart of an exemplary, illustrative method for payment transfer to a preferred embodiment of a monetary instrument according to the present invention;

FIG. 5 relates to an additional, optional embodiment of the system of FIG. 1;

FIG. 6 shows an optional, illustrative flow diagram of payment between a paying party and a recipient party, through a third party payment service, according to preferred embodiments of the present invention;

FIG. 7 shows an optional but preferred embodiment of the payment module according to the present invention;

FIG. 8 shows an exemplary method according to some embodiments of the present invention for expedited payment to the recipient;

FIG. 9 shows an exemplary system according to some embodiments of the present invention for a hosted back office; and

FIG. 10 shows an exemplary method according to some embodiments of the present invention for providing a pre-screening tool.

### DESCRIPTION OF THE PREFERRED EMBODIMENTS

The present invention is of a system and method for payment transfer between a paying party and a recipient party. Optionally and preferably, payment transfer is made by using a prepaid card, which has many security and administrative advantages. The paying party is optionally a media content provider while the recipient party is optionally a user who provides content, although many different combinations of paying/recipient parties may optionally be implemented.

According to preferred embodiments of the present invention, the paying party pays the recipient party for performing one or more activities, including but not limited to one or more activities regarding the provision of goods and/or services. According to preferred embodiments of the present invention, the goods and/or services preferably comprise content as described herein, including but not limited to page views (for web site or video for example), funds received for advertisements in relation to provision of content and/or other goods and/or services, a fee or fees paid per download of content and/or other goods, subscription payments (for example for a channel of content and/or for receiving content and/or other good(s) from a particular user) and the like. Payment may optionally be split among a plurality of recipients as described in greater detail below.

According to preferred embodiments of the present invention, a third party payment service may optionally and preferably provide a hosted payment service to a paying party, which may for example be a content provider. The hosted payment service preferably includes provision of a web page and/or other software interface for enabling the paying party and/or recipient party (such as the party providing the content) to interact with the hosted payment service. For example, the latter party could optionally provide identification information and/or details for receiving payment, while the former party could optionally upload information regarding payment to the recipient party and/or receive one or more reports regarding payment. The provided interface is preferably standardized for a plurality of paying parties, but may also optionally be customized for one or more such parties. Optionally and preferably, the web site and/or other software interface of the paying party redirects recipient parties to this page and/or software interface for selecting a preferred mechanism of payment and for providing appropriate credentials such as identification information. Also optionally, according to such parameters as geographic information, age of a receiving individual and so forth, the third party payment service interface may direct selection of a payment mechanism, for example by limiting the choice(s) being offered.

According to other preferred embodiments of the present invention, the mechanism of payment selected by the recipient party is transparent to the paying party, as the third party payment service preferably handles the details regarding the mechanism of payment. Such transparency enables the paying party to handle payments, preferably including batch payments, without being required to determine all of the details for each payment mechanism. For example, preferably the paying party is able to handle payments through a payment interface to the third party payment service, rather than having a separate interface for each payment mechanism.

Alternatively or additionally, payment may be made for a variety of reasons, including but not limited to, a gift, reimbursement and/or other types of remuneration.

As described in greater detail below, payment is preferably provided through a prepaid card, which is preferably requested through an electronic medium such as the Internet for example by a paying party and which is then preferably sent to a recipient party. Provision of the prepaid card is preferably made by a third party payment service, which may also optionally handle the transfer and provision of funds.

According to some preferred embodiments of the present invention, there is provided an exemplary method for expedited payment to the recipient, preferably in conjunction with one or more of the payment methods described herein. For example, if the user is the recipient of a prepaid card and/or other financial instrument to which funds are optionally and preferably provided according to one or more aspects of the present invention as described herein, payment to the user may optionally and preferably be expedited. The user may optionally be provided with this choice upon notification of the availability of funds, for example for micropayments (although optionally any type of payment may be used herein). Preferably a fee is charged, more preferably with regard to the risk incurred (for example if covering funds had not yet been received from a paying party). Without limitation, such a method could be used for example with regard to payment for user provided content as described herein.

According to other preferred embodiments of the present invention, there is provided a system and method for a hosted back office for a paying party, which preferably handles a plurality (and more preferably is capable of handling all) of the interactions between a paying party, a recipient party and a third party payment service. Optionally the hosted back office may incorporate the third party payment service. The interactions preferably include but are not limited to one or more of notification of funds being provided to the recipient party, for example through a prepaid card and/or any other type of financial instrument; communication between the recipient and the paying party; communication between the paying party and the third party payment service; and the like.

According to still other preferred embodiments of the present invention, there is provided an exemplary method for a pre-screening tool for identifying a recipient of a financial instrument. The financial instrument may optionally be provided electronically, for example through an electronic gift certificate and/or account, or any type of “e-money” or monies to be provided to a recipient using electronic media, as described herein. The financial instrument may optionally, additionally or alternatively, be provided in the form of a physical object, such as a debit card, paper certificate and the like. The exemplary method described herein centers around the provision of an identity to a recipient according to a physical address, and in particular with regard to the AVS system, but could optionally be used for any type of pre-screening and identification.

The AVS system (address verification system) as implemented today is a security system for preventing a common form of online credit card fraud. AVS compares the billing address information provided by the customer with the billing address on file at the customer's credit card issuer. The merchant receives an AVS response code, which typically indicates whether the provided billing address is commensurate with the known billing address (or optionally only a part of the billing address, such as the zip code for example) and then either accepts or declines the transaction according to one or more parameters. AVS may also optionally involve an internal analysis of the billing address, to make certain that the different components are commensurate with each other (for example, that the town name or town name/street address is consistent with the provided zip code). Currently, the AVS system is only available for US addresses and so cannot be used for international transactions.

The method of the present invention overcomes the above drawback of the AVS system by enabling the AVS system to be used with non-US addresses with the addition of anti-fraud checking and identity verification. Preferably, once the user has registered to a system according to some embodiments of the present invention, the user is provided with a virtual US address. More preferably, the user provides a non-US physical address which can be most preferably verified in some manner, to correspond to the virtual US address. For example, the user may optionally be provided with some type of information through the mail which is sent to the physical address.

The principles and operation of the present invention may be better understood with reference to the drawings and the accompanying description.

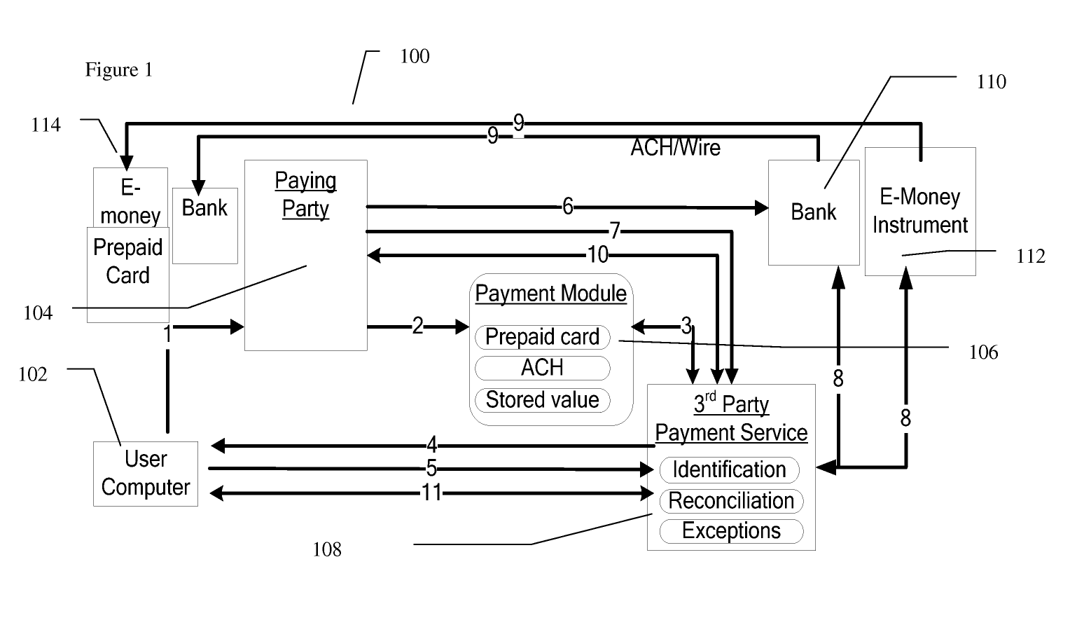

Referring now to the drawings, FIG. 1 is a schematic block diagram of an exemplary, illustrative system and process flow for payment transfer according to the present invention. As shown, a system 100 preferably features a user computer 102 operated by a user (not shown) who communicates with a media content provider 104, preferably through online communication. According to preferred embodiments of the present invention, such online communication features exchanging information through Web pages according to HTTP (HyperText Transfer Protocol) or any other protocol for communication with and through mark-up language documents. For example, preferably user computer 102 operates a Web browser through any type of computational device, while media content provider 104 preferably also features at least one computational device for communicating with user computer 102, preferably through mark-up language documents. Media content provider 104 is shown as the paying party in FIG. 1; however, media content provider 104 may also optionally contract with an external party, such as a payment service for example, to handle the payment aspects of the flow described herein, in addition to those aspects of the below flow handled by payment service module 108.

An arrow “1” shows the user, through user computer 102, optionally and preferably registering with media content provider 104, which more preferably comprises one or more of providing a user name and/or other identifier as well as some type of payment identification information, as described in greater detail below. Optionally, the user identifier is relative, such that it enables media content provider 104 to at least determine the identity of the user relative to the payment identification information (as opposed to an absolute form of identification, such as a national identification number for example). Through user computer 102, the user optionally provides user created content to media content provider 104 (not shown as part of a process).

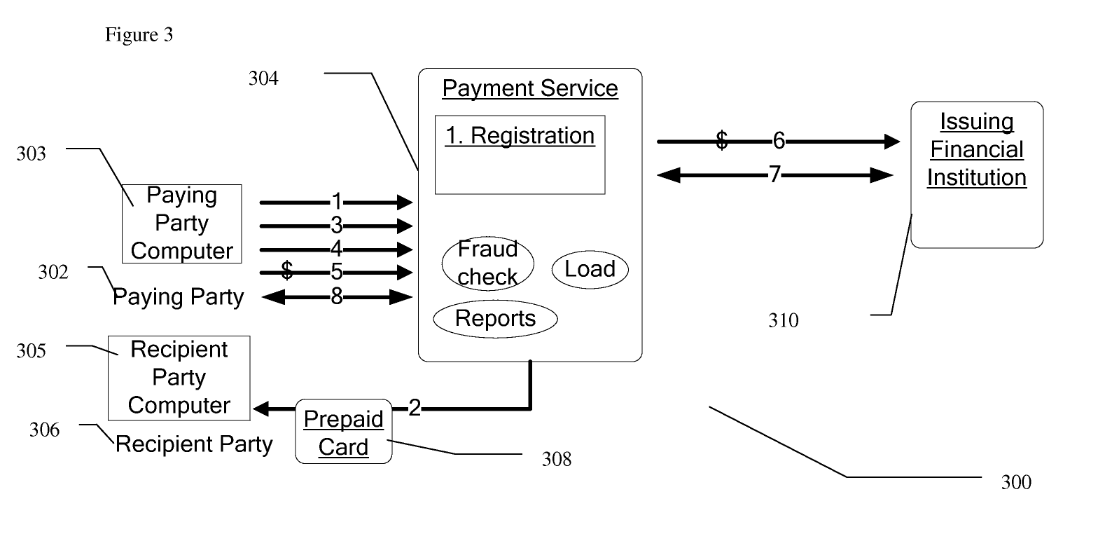

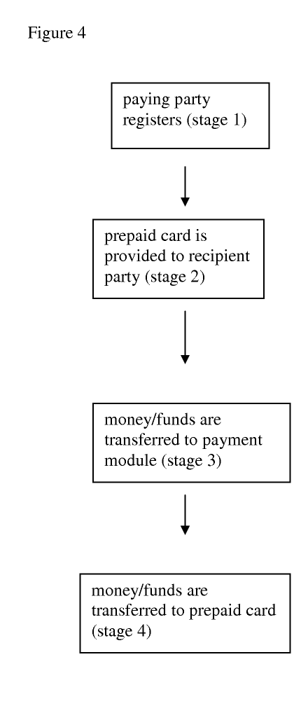

According to preferred embodiments of the present invention, payment identification information is provided through a payment module 106 as shown. Payment module 106 may optionally be operated by media content provider 104, or alternatively may be operated by a third party, such as some type of financial company (including but not limited to a bank, an electronic check provider, a credit card acquirer or issuer, or other type of money service business and so forth), or may be operated by a combination thereof. Arrow “2” shows user computer 102 optionally and preferably providing payment identification information to payment module 106. Such payment identification information preferably comprises a type of monetary instrument, and optionally also an identifier for the monetary instrument, such as a bank account number for a bank account for example. Examples of monetary instruments preferably include but are not limited to e-money cards and accounts, credit cards, electronic checks and micropayment mechanisms of various types. A non-limiting example of an e-money card or account is PayPal (paypal.com), while a non-limiting example of an electronic check service is ACH (Automated Clearing House Network; nacha.org). According to preferred embodiments of the present invention, payment is preferably made through an exemplary monetary instrument according to the present invention as described with regard to FIGS. 3 and 4 below.

Once the user, through user computer 102, has provided payment identification information through payment module 106, optionally and preferably payment service module 108 verifies that the identification information for the user matches the payment identification information, as shown by an arrow “3”. Payment service module 108 may optionally be operated by a third party, such as a financial institution and/or other third party, which is optionally and preferably the party operating payment module 106.

Payment service module 108 (shown as a third party payment service for the sake of description only and without any intention of being limiting) may optionally then initiate a new monetary instrument or confirm an existing monetary instrument in order for the user to receive payment. One preferred embodiment of such a monetary instrument is described in greater detail below. However, optionally payment service module 108 transmits information about a new or existing monetary instrument to the user for activation, which may optionally include the monetary instrument itself (as for some type of prepaid card), preferably through user computer 102 as shown by arrow “4” (although this transmission could also optionally be performed through some other type of communication). Through user computer 102 (or alternatively through some other type of communication), the user preferably confirms receipt of this information to payment service module 108, as shown by arrow “5”.

In any case, once the payment identification has been verified and optionally one or more additional processes are performed to make payment possible, media content provider 104 preferably initiates payment to the user by transmitting funds and/or payment instructions to a bank 110, as shown by arrow “6”. Media content provider 104 also preferably sends instructions to payment service module 108 regarding the payment to be made to the user as shown by arrow “7”. Next payment service module 108 preferably reconciles payment with bank 110, as shown by arrow “8”. More preferably, payment service module 108 provides instructions for payment to bank 110, which then executes these instructions. Optionally, additionally or alternatively, another type of financial instrument may be used for executing payment instructions, such as an instrument provided by an electronic funds institution 112 such as PayPal for example.

Regardless, the financial institution (such as bank 110 and/or electronic funds institution 112) preferably then transmits money to a monetary instrument 114 controlled by the user as shown by arrow “9”. Non-limiting examples of such monetary instruments may optionally be as described herein and/or as shown in FIG. 1, although other types of financial instruments may also optionally (additionally or alternatively) be used.

Payment service module 108 preferably provides a report to media content provider 104 regarding payment reconciliation and optionally including any errors such as for returned payment, incorrect credentials or identification, amount differences and so forth, as shown by arrow “10”. The user, preferably through user computer 102 (or alternatively through some other type of communication) also optionally and preferably accesses reports from the payment service module 108 regarding receipt of funds and optionally any problems with fund receipt (shown by arrow “11”).

According to optional but preferred embodiments of the present invention, media content provider 104 may optionally comprise an interface module for communicating with payment service module 108 (not shown). This interface module preferably features one or more functions for collecting data and for transferring data to payment service module 108. More preferably, the interface features one or more functions for performing the necessary calculations for determining to whom payment should be made and/or the amount(s) to be paid, most preferably also comprising instructions to the financial institution(s) for payment.

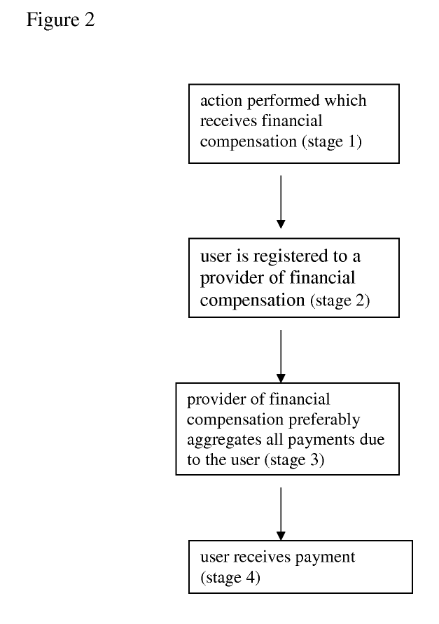

FIG. 2 is a flowchart of an exemplary, illustrative method for payment transfer according to the present invention. As shown in stage 1, an action is performed on-line which receives financial compensation. Such an action may optionally relate to user created content as for FIG. 1, but may also optionally relate to any type of action as described herein for which some type of financial compensation is to be provided. The action may optionally be performed by the user and/or may relate to actions performed by others (as for example when an affiliate Web site provides a link that is clicked on for a “click through” to another Web page). The exact type of action performed is not relevant to the performance of these preferred embodiments of an exemplary method according to the present invention.

In stage 2, the user is registered to a provider of financial compensation. This stage may optionally be performed before or concurrently with stage 1. Also, the provider of financial compensation may optionally be the same organization as for receiving the benefit of the action performed (such as an on-line media company in the case of user created content), but is preferably a separate financial provider.

In stage 3, the provider of financial compensation preferably aggregates all payments due to the user. Also preferably this stage is performed for a plurality of users in parallel. If the provider of financial compensation is different from the organization receiving the benefit of the action, then preferably the latter party sends instructions to the provider of financial compensation in order for aggregation to occur.

In stage 4, the provider of financial compensation preferably transfers payment to a monetary instrument of the user. Optionally, the provider of financial compensation provides the monetary instrument itself to the user, as described with regard to FIGS. 3 and 4 below. The monetary instrument is preferably a prepaid card of some type, but may optionally be electronic funds or a regular bank account, for example.

Financial compensation may optionally be calculated for provision of a variety of goods and/or services, including but not limited to page views (for web site or video for example), funds received for advertisements in relation to provision of content and/or other goods and/or services, a fee or fees paid per download of content and/or other goods, subscription payments (for example for a channel of content and/or for receiving content and/or other good(s) from a particular user) and the like. According to other preferred embodiments, payment may not be provided on a “one to one” basis, in which a single provider and/or author and/or creator of goods and/or services, such as content for example, receives a payment. Instead, optionally license payments may optionally be split among a plurality of providers and/or authors and/or creators; for example, for video content, a license payment may optionally be split to provide 10% to an actor, 20% to a director, a separate payment for music rights on the soundtrack and so forth.

According to preferred embodiments, payment is provided to the content provider according to a trigger, such that optionally a plurality of micropayments is collected and paid at one time. The trigger may optionally be related to amount (such that the total collected micropayments are at least at or above a threshold amount) and/or elapsed time since the previous payment.

FIG. 3 is a schematic block diagram of an exemplary, illustrative system and process flow for payment transfer to a preferred embodiment of a monetary instrument according to the present invention. As shown, a system 300 features a paying party 302, operating a paying party computer 303, and a recipient party 306, operating a recipient party computer 305. Payment is made with the assistance of a payment module 304 (shown as a payment service in the Figure for the sake of description and without any intention of being limiting in any way).

Paying party 302 preferably registers with payment module 304, optionally and preferably providing various identification and/or payment identification details, shown by arrow “1”, more preferably by operating paying party computer 303. Optionally and preferably communication between paying party 302 and payment module 304 is performed through on-line communication, for example through paying party computer 303. According to preferred embodiments of the present invention, such online communication features exchanging information through Web pages according to HTTP (HyperText Transfer Protocol) or any other protocol for communication with and through mark-up language documents. For example, preferably paying party computer 303 operates a Web browser or implements automated software for managing payments through any type of computational device, while payment module 304 preferably also features at least one computational device for communicating with paying party computer 303, preferably through mark-up language documents.

Preferably following verification of these details by payment module 304, a monetary instrument is optionally sent to recipient party 306, shown by to arrow “2”. The monetary instrument preferably comprises a prepaid card 308. Optionally, depending upon the request of paying party 302 and/or recipient party 306, and/or one or more details about paying party 302 and/or recipient party 306 (such as geographical location or credentials (identification and/or payment history and/or other characteristic(s) of one or both parties) for example), prepaid card 308 may function as a full debit card and/or be restricted for cash withdrawals from automated banking machines such as ATM machines for example.

Paying party 302 then preferably communicates with payment module 304 to activate prepaid card 308, optionally by providing details such as the PIN number and/or other information required for activation, as shown by arrow “3”, for example through paying party computer 305. The functions of arrows “1” and “3” may optionally be performed simultaneously or sequentially.

Paying party 302 preferably communicates with payment module 304 to provide money (funds) for loading to prepaid card 308, as shown by arrow “4”, preferably through paying party computer 305. Payment module 304 preferably performs one or more checks for fraud and/or other illegal activity. The functions of arrows “1”, “3” and “4” may optionally be performed simultaneously and/or in various combinations. Money (funds) is then transferred from paying party 302 and/or a third party financial institution thereof (such as a credit card company for example) to payment module 304, shown in arrow “5”.

Payment module 304 preferably transfers the money/funds to an issuing financial institution 310, which is preferably the issuer for prepaid card 308, as shown by arrow “6”. More preferably, payment is transferred after deducting a fee for payment module 304. Optionally, money/funds are transferred directly from paying party 302 to issuing financial institution 310, which then preferably transfers the deducted fee back to payment module 304, optionally after deducting its own fee.

Payment module 304 preferably communicates with issuing financial institution 310 in order to determine how much money/funds should be added to prepaid card 308 and/or the type of money/funds which should be added (optionally in relation to the type of currency for example and/or the type of optional restriction(s) to be placed on the use of the money/funds), as well which type(s) of payment activities are permitted with prepaid card 308. Such communication also preferably enables payment module 304 to receive reports from issuing financial institution 310 concerning activity or activities with prepaid card 308, including but not limited to, amounts added to prepaid card 308, balance remaining, purchase(s) with prepaid card 308 and so forth. Such communication is shown with regard to arrow “7”. Optionally and preferably, the content of such report(s) may be made available, partially or completely to paying party 302 and/or recipient party 306, depending upon the relationship between the parties and/or agreement between the parties, as shown by arrow “9”. For example if paying party 302 is the parent of recipient party 306 who is a minor, then preferably a detailed report is provided including a record of all purchases or withdrawals. Alternatively, if paying party 302 is a media content provider on-line and recipient party 306 has provided content to the provider, presumably paying party 302 would not receive such a detailed report.

Optionally, paying party 302 could place restrictions on the types and/or locations of purchases with prepaid card 308, particularly if paying party 302 is the parent of or otherwise responsible for recipient party 306. For example, for children under the legal drinking age, prepaid card 308 could be blocked from being used for purchases of alcohol. A similar restriction could be made for smoking. A parent could also decided that prepaid card 308 could not be used for purchases of CDs or other forms of music, but could be used for purchases of books for example. Even if paying party 302 is not responsible for recipient party 306, restrictions could still optionally be placed, for example regarding the use of prepaid card 308 for on-line betting or gambling, which is illegal in certain jurisdictions.

According to preferred embodiments of the present invention, paying party 302 could optionally and preferably request a hold or delay on one or more types of payment activities by recipient party 306, for example according to the amount and/or type of purchase. Such a hold or delay could optionally still permit recipient party 306 to perform the payment activity but only after a particular period of time had passed (such as 24 hours for example). Such a hold or delay could optionally permit paying party 302 to discuss the payment activity with recipient party 306 (as in the case of a parent and teenager, for example).

Optionally and preferably, paying party 302 could request a hold or delay for money to be paid to prepaid card 308.

According to other preferred embodiments of the present invention, paying party 302 could optionally and preferably request a message to be sent according to an attempt to perform one or more types of payment activities by recipient party 306, for example according to the amount and/or type of purchase. Such a message could optionally be sent by SMS and/or by e-mail and/or any other type of messaging system, including but not limited to those described herein, as is known in the art. The message could also optionally be combined with a hold or delay as described, or even with a total block on the payment activity. Most preferably, the parameters for a hold or delay, or block, and/or message regarding a payment activity, are set by paying party 302, for example through one or more reports generated by payment module 304.

According to yet other preferred embodiments of the present invention, paying party 302 could optionally and preferably view one or more reports generated by payment module 304, regarding the payment activity or activities by recipient party 306. Such a report may optionally be sent by e-mail and/or SMS and/or other messaging system as is known in the art, and/or may be made available through a Web page and/or another type of software interface on paying party computer 305, for example.

System 300 of FIG. 3 could optionally be used in conjunction with system 100 of FIG. 1, in that paying party 302 could optionally comprise media content provider 104, while recipient party 306 could optionally comprise the user of user computer 102. Therefore, the user could optionally and preferably be paid for providing user generated content to media content provider 104 by using prepaid card 308.

FIG. 4 is a flowchart of an exemplary, illustrative method for payment transfer to a preferred embodiment of a monetary instrument according to the present invention. In stage 1, the paying party registers with the payment module, preferably providing identification and/or payment identification details for the paying party and more preferably also providing at least identification information concerning the recipient party.

In stage 2, a prepaid card is provided to the recipient party, which is preferably a physical card (optionally with a magnetic swipe strip) but which alternatively only comprise a card number. In stage 3, money/funds are provided to the payment module by the paying party. It should be noted that stages 1-3 may optionally be performed sequentially in various orders and/or simultaneously.

In stage 4, money/funds are provided (loaded) to the prepaid card by the payment module, after which the prepaid card may optionally be used by the recipient party.

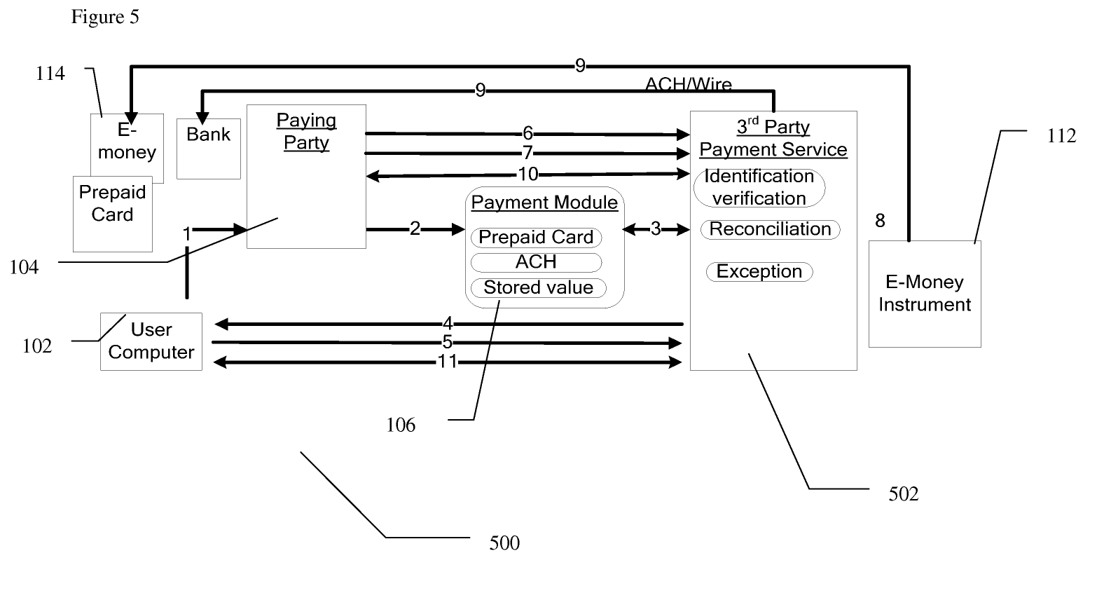

FIG. 5 relates to an additional, optional embodiment of the system of FIG. 1. Elements which have the same number as for FIG. 1 have the same or at least similar function unless otherwise indicated. In a system 500 as shown, a payment service module 502 optionally and preferably comprises a bank (and/or is a bank). Payment service module 502 may also optionally and preferably comprise electronic funds institution 112. In this embodiment, payment service module 502 preferably performs one or more, or even all, of the functions of the bank in the system of FIG. 1, as well as performing the function(s) of the payment service module of the system of FIG. 1.

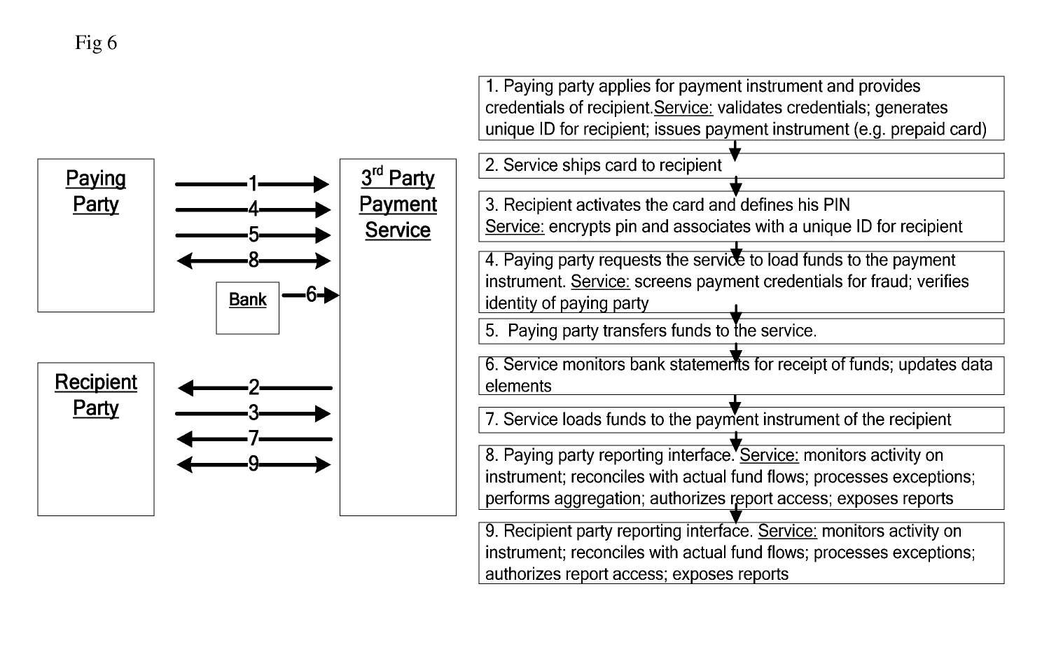

FIG. 6 shows an optional, illustrative flow diagram of payment between a paying party and a recipient party, through a third party payment service, according to preferred embodiments of the present invention. As shown, in an action shown by arrow “1”, the paying party applies for a payment instrument and provides one or more identification information (credentials) of the recipient party to the third party payment service. The third party payment service then preferably validates the identification information (credentials), generates a unique identifier for the recipient party and issues the payment instrument. In this non-limiting example, the payment instrument comprises a prepaid card as described herein.

Next, as shown by arrow “2”, the third party payment service ships the prepaid card to the recipient party. As shown by arrow “3”, the recipient party then preferably activates the prepaid card and more preferably defines a PIN (personal identification number) and/or other identifier. The PIN and/or other identifier is preferably provided to the third party payment service, which more preferably encrypts the PIN and/or other identifier, and associates it with the unique identifier for the recipient party.

As shown by arrow “4”, the paying party preferably requests that the third party payment service loads funds to the payment instrument such as the prepaid card for example. The third party payment service preferably screens the payment credentials and/or identification information for fraud and/or money laundering, and more preferably verifies the identity of the paying party.

Next, preferably the paying party preferably transfers funds to the third party payment service, as shown by arrow “5”. Any suitable fund transfer mechanism may optionally be used, such as for example an ACH instruction to initiate the transfer of funds from a bank account of the paying party to the third party payment service. Preferably the ACH instruction would be generated automatically by the payment service at fixed intervals for an aggregation of recipient payments. Optionally the media content provider or other entity which is to provide payment may initiate this stage; alternatively, an external payment service may optionally initiate this stage, preferably upon receiving instructions from the media content provider or other entity.

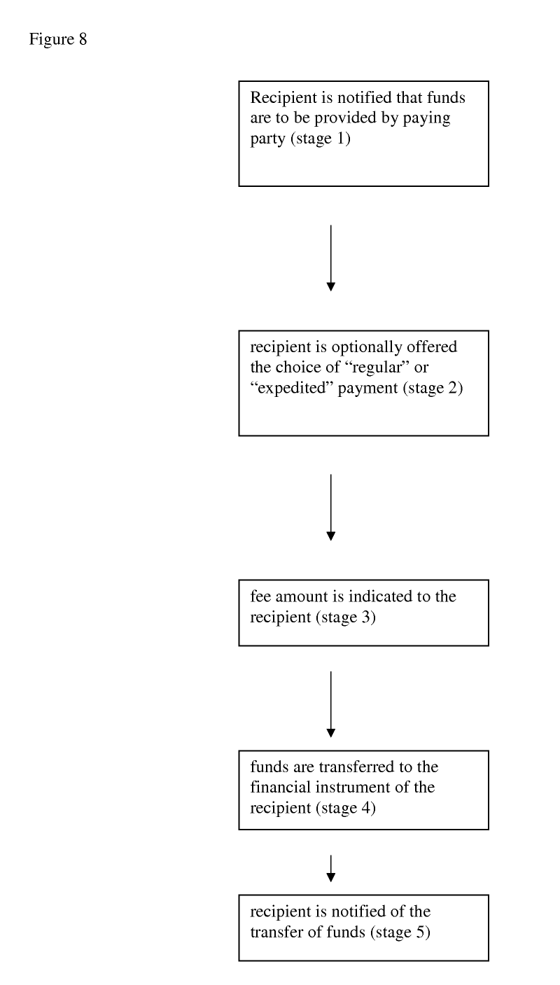

As shown in arrow “6”, the third party payment service preferably monitors for receipt of funds, for example by monitoring bank statements or status reports, and updates one or more data elements and/or database(s) as necessary. This verification process is preferably performed to ensure that funds are received from the paying party before any funds are provided to the recipient. As described in greater detail below with regard to FIG. 8, according to some embodiments of the present invention, expedited payment may optionally be requested, in which funds are loaded to the payment instrument of the recipient rapidly, optionally prior to verification of receipt of payment by the third party payment service. Such expedited payment potentially incurs a credit risk by the payment service.

Next, the third party payment service preferably loads funds to the payment instrument of the recipient party, as shown by arrow “7”.

Optionally and preferably, there is provided a paying party reporting interface as shown by arrow “8”, which preferably enables the third party payment service to report on one or more of the following to the paying party: monitor activity on the financial instrument; reconcile reported activity or activities with actual fund flows; process exceptions; perform aggregation; authorize report access; and/or provide or display such reports.

Also optionally and preferably, there is provided a recipient party reporting interface as shown by arrow “9”, which preferably enables the third party payment service to report on one or more of the following to the recipient party: monitor activity on the financial instrument; reconcile reported activity or activities with actual fund flows; process exceptions; perform aggregation; authorize report access; and/or provide or display such reports.

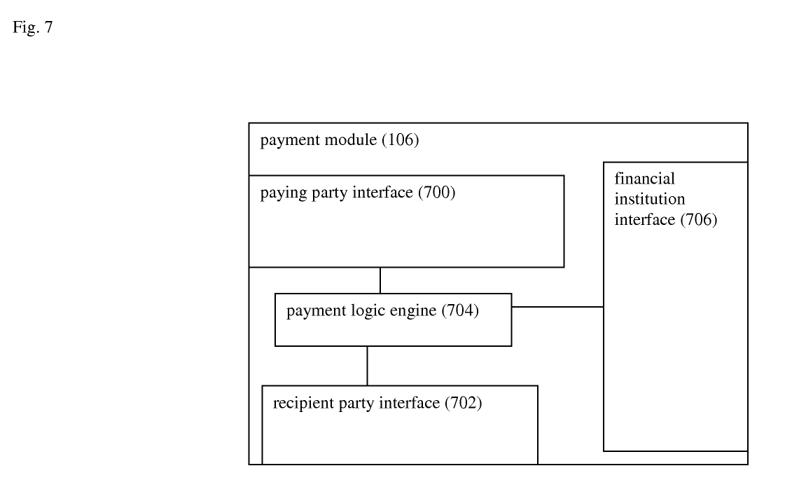

FIG. 7 shows an optional but preferred embodiment of the payment module according to the present invention. As shown, payment module 106 preferably comprises a paying party interface 700 and a recipient party interface 702. Each of paying party interface 700 and recipient party interface 702 preferably provides an external interface (such as a Web page and/or other software interface for example) to the paying party or recipient party, respectively. This external interface (not shown) is optionally customized according to a request of a paying party, such that each paying party may have the external interface or display of paying party interface 700 and recipient party interface 702 customized according to one or more customization preferences.

Payment module 106 preferably obtains information regarding payments to be made by the paying party through paying party interface 700 and preferably receives information regarding details of how the payment is to be received by the recipient party through recipient party interface 702. This information is preferably fed to a payment logic engine 704, which then in turn sends instructions for payment to a financial institution interface 706. The financial institution may optionally be part of the third party payment service or may alternatively be a separate institution, as previously described. Financial institution interface 706 is preferably adjusted to be compatible with the proprietary protocol(s) of the financial institution, as is known in the art.

Data elements obtained by payment module 106 for use by payment logic engine 704 preferably differ depending on the payment method selected by the recipient: ACH—Bank name, branch and account number; Paypal or other e-account and/or e-funds: email address, password; Prepaid card (as described for example herein): Card number, PIN; and so forth. Optionally, such data may be stored in a database accessed by payment module 106 (not shown).

Optionally, recipient party interface 702 may display a plurality of different options for payment mechanisms, but optionally and preferably these options are limited according to one or more parameters. For example, a payment mechanism option may optionally and preferably be selected according to one or more characteristics of the recipient party. Non-limiting examples of such characteristics include country, as non US recipients are not offered ACH as an option, since it is currently only available in the US; age, as minors are preferably offered prepaid cards which can be used to draw cash from ATM machine and/or for payment as previously described (optionally with parental or guardian control as previously described); or the nature of the relationship between the paying party and the recipient party. As a non-limiting example of the last, if the paying party is a content provider and the recipient party is a content publisher, the recipient party may optionally be offered instruments with higher fraud risk as funds can only be loaded by the paying party.

Optionally and preferably, recipient party interface 702 is generic for the type of payment mechanism; details and parameters which should be provided according to the type of payment mechanism are preferably determined by payment logic engine 704. Similarly, payment logic engine 704 preferably selects one or more options for the type of payment mechanism to be given through recipient party interface 702 according to one or more details about the recipient party. For example, if the recipient party is redirected to recipient party interface 702 as a Web page from the paying party Web site, then preferably payment logic engine 704 preferably selects one or more options for the type of payment mechanism according to one or more details about the recipient party which are more preferably provided by the paying party while redirecting the recipient party to a web page of payment module 106.

FIG. 8 shows an exemplary method according to some embodiments of the present invention for expedited payment to the recipient. As shown, in stage 1, the recipient is notified that funds are due to be provided by the paying party. Such notification may optionally occur through any type of messaging mechanism, including but not limited to e-mail, SMS or any other cellular to telephone based messaging, telephone contact (optionally including a voice call), regular mail, facsimile, IM (instant messaging), any type of “push” or “pull” protocols to a computer and the like. Optionally, additionally or alternatively, the recipient may “log on” to or otherwise provide identification to a website and so review the information through a mark-up language document (referred to herein as a “web page”).

In stage 2, the recipient is optionally offered the choice of “regular” or “expedited” payment. The latter payment mechanism causes funds to be loaded to the payment instrument of the recipient more rapidly than for “regular” payment. The extent to which payment is made more rapidly may optionally vary within any time difference, from seconds to minutes to hours to days to weeks to months and so forth. Preferably the recipient is informed of the time difference, optionally as an estimate. Also optionally the recipient is offered the choice of multiple levels of expedited service.

Optionally and preferably, a fraud risk assessment of the recipient (and also more preferably of the paying party) is performed before the expedited payment option is offered. Also optionally, the degree to which expedited payment is in fact expedited may be at least partially determined according to a fraud risk assessment of the recipient (and also more preferably of the paying party).

In stage 3, a fee amount is indicated to the recipient if the recipient selects the expedited payment option. The fee amount may optionally vary according to the level of risk accepted by the third party payment service. For example, optionally funds are provided to the recipient prior to verification of receipt of payment by the third party payment service. Such expedited payment potentially incurs a credit risk by the payment service and so the fee needs to be set commensurately higher. Stages 2 and 3 may optionally be performed together.

In stage 4, regardless of the type of payment selected, funds are transferred to the financial instrument of the recipient as previously described herein, preferably after deducting any necessary fees. Optionally the funds may be split between multiple financial instruments as requested by the recipient.

In stage 5, the recipient is notified of the transfer of funds, optionally and preferably through any of the previously described mechanisms, optionally including having the recipient “log in” to a website.

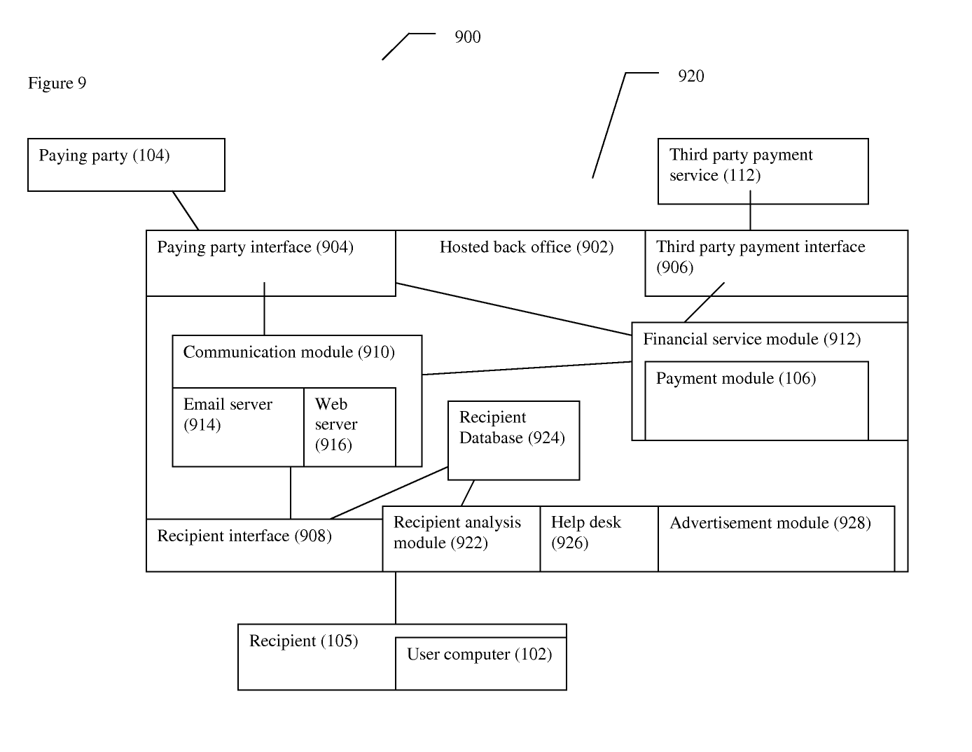

FIG. 9 shows an exemplary system according to some embodiments of the present invention for a hosted back office. As shown, a system 900 features paying party 104, third party payment service 112, recipient 105 and a hosted back office 902 for communication between them, more preferably through a computer network 920. Optionally, third party payment service 112 and hosted back office 902 are combined (not shown).

Hosted back office 902 preferably handles one or more financial and/or other “back office” services for paying party 104, which may optionally be any type of merchant but which preferably provides micropayments to a plurality of recipients 105 as described herein. Hosted back office 902 preferably provides merchants such as paying party 104 with a single, easy-to-use, secure and compliant environment to conduct their payment activities, which is also protected against fraud. Hosted back office 902 preferably communicates with paying party 104 through a paying party interface 904, with third party payment service 112 through a third party payment service interface 906 and with recipient 105 through a recipient interface 908.

As a non-limiting example of the back office services provided, hosted back office 902 preferably handles financial transactions between paying party 104 and third party payment service 112 through a financial service module 912. These transactions optionally include but are not limited to those involving payment to recipient 105, for example through payment module 106 as previously described. At least one financial service preferably includes coordinating payment to a plurality of recipients 105, in which the payment comprises a plurality of aggregated micropayments. However, these services also preferably include handling payment of other types of invoices, calculating accounts receivable, handling incoming payments from clients (not shown) and the like.

Hosted back office 902 preferably also provides a plurality of services to paying party 104 with regard to interactions with recipient 105. For example, hosted back office 902 optionally and preferably performs at least some, and more preferably all or substantially all, communication with recipient 105 through a communication module 910. Most preferably, such communication is “branded” or features the name and/or logo and/or “trade dress” of paying party 104. Optionally and most preferably, such communication does not feature an indication of its origin with hosted back office 902. Communication module 910 preferably communicates with recipient interface 908, which as described in greater detail below may optionally comprise a plurality of communication mechanisms. Communication module 910 preferably includes an e-mail server 914, and a web server 916 as well as optionally other types of messaging mechanisms as described herein (not shown).

E-mail server 914 optionally and preferably is used to send one or more e-mail messages to recipient 105, preferably through user computer 102 as shown, which as previously described are preferably branded according to paying party 104. Such e-mail messages are example of a type of communication which may optionally and preferably be included within recipient interface 908. More preferably, recipient 105 is able to send one or more e-mail messages through user computer 102 back to paying party 104 through e-mail server 914. Optionally, also as described in greater detail below, hosted back office 902 may analyze the message and provide the reply, automatically or manually. Also optionally, hosted back office 902 may analyze the message and provide the parsed information to paying party 104, whether in terms of information from a particular recipient 105 and/or aggregated information received from a plurality of recipients 105.

These e-mail messages may optionally relate to payment but may also, additionally or alternatively, optionally relate to other aspects of communication between paying party 104 and recipient 105. As described in greater detail below, these aspects of communication may optionally be customized to a group of recipients 105 and/or personalized for a particular recipient 105.

Web server 916 is preferably used to provide mark-up language documents, particular web pages, to recipient 102, preferably through user computer 102. Such a web page may optionally be included within recipient interface 908. Preferably a web page is provided which requires the recipient to “log on” or otherwise provide identification, for example in order to view account information. The web page may optionally be used for other types of communication as well from paying party 104, including but not limited to advertisements as described in greater detail below. Recipient 105 may also optionally provide information, for example a message, to paying party 104 through the web page operated by user computer 102.

Branding may also optionally be extended to the financial instrument provided to recipient 105, such as for example a payment card of some type as described herein.

A recipient analysis module 922 preferably analyzes communication through recipient interface 908, more preferably including analysis of e-mail messages and interactions with provided web page(s). The analysis preferably includes aggregated information from a plurality of recipients 105, which more preferably may be provided to paying party 104 in the form of a report, and which most preferably includes statistical analysis. For example, if paying party 104 wishes to require recipient 105 to answer a question (for example in a survey) and/or to view a message before receiving account information and/or payment, recipient analysis module 922 preferably analyzes the recipient response. Such an analysis preferably includes but is not limited to whether recipient 105 responds (for example by “clicking” on or otherwise selecting a button or other GUI gadget, by sending an e-mail message or an SMS, and so forth), whether recipient 105 answers the question and/or views the message, any opinion expressed by recipient 105 and so forth.

The analysis may also optionally include an individual response by a particular recipient 105 to any of the above, in order to learn more about the recipient's habits, taste, opinions and so forth. For example, a particular recipient 105 may respond well to an e-mail message but may not bother to “log in” to the website, indicating the type of preferred communication for such a recipient 105.

Recipient analysis module 922 then preferably stores such analyzed information in a recipient information database 924.

Recipient analysis module 922 also preferably supports a help desk module 926, for assisting recipient 105 with any difficulties regarding communication, the recipient's account, payment problems and the like. Recipient analysis module 922 preferably uses information obtained by analyzing the action(s) of recipient 105 in order to better assist recipient 105. More preferably, a log of all help desk activities is maintained in recipient information database 924.

Recipient analysis module 922 also preferably supports a targeted advertising module 928, for providing one or more targeted advertisements to recipient 105 through user computer 102 recipient interface 908. Such targeting is preferably based on information known about the recipient, more preferably including demographic information, as well as information gathered through the previously described analysis process. An advertiser can upload and/or push the advertisements to targeted advertising module 928, which would then provide them through recipient interface 908. The advertisements could optionally be provided to a category of recipients and/or personalized for a specific recipient. The advertisements could also optionally feature a coupon, providing a discount to recipient 105 if the provided funds are used to purchase a particular product and/or a product from a particular company and/or from a particular store, more preferably an on-line store and/or a web merchant, such as Amazon® for example.

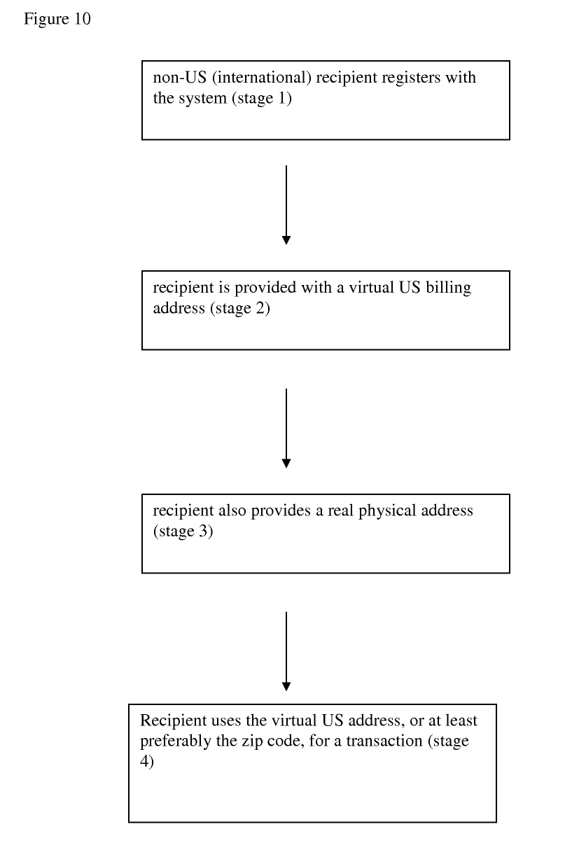

FIG. 10 shows an exemplary method according to some embodiments of the present invention for providing a pre-screening tool for identifying a recipient of a financial instrument in advance. The financial instrument may optionally be provided electronically, for example through an electronic gift certificate and/or account, or any type of “e-money” or monies to be provided to a recipient using electronic media, as described herein. The financial instrument may optionally, additionally or alternatively, be provided in the form of a physical object, such as a debit card, paper certificate and the like. The exemplary method described herein centers around the provision of an identity to a recipient according to a physical address, and in particular with regard to the AVS system, but could optionally be used for any type of pre-screening and identification.

The AVS system (address verification system) as implemented today is a security system for preventing a common form of online credit card fraud. AVS compares the billing address information provided by the customer with the billing address on file at the customer's credit card issuer. The merchant receives an AVS response code, which typically indicates whether the provided billing address is commensurate with the known billing address (or optionally only a part of the billing address, such as the zip code for example) and then either accepts or declines the transaction according to one or more parameters. AVS may also optionally involve an internal analysis of the billing address, to make certain that the different components are commensurate with each other (for example, that the town name or town name/street address is consistent with the provided zip code). Currently, the AVS system is only available for US addresses and so cannot be used for international transactions.

The method of the present invention overcomes the above drawback of the AVS system by enabling the AVS system to be used with non-US addresses with the addition of anti-fraud checking and identity verification.

In stage 1, a non-US (international) recipient registers with the system according to the present invention as described herein. Preferably one or more background “checks” or examinations are performed to guard against fraud and/or money laundering. Such examinations are also preferably performed for identity verification.

In stage 2, the recipient is provided with a virtual US billing address. The virtual address preferably is related to an actual physical US address. To avoid duplication, the address may optionally be linked with a plurality of unit identifiers, such that each recipient would receive a unique unit identifier (or at least a shared unit identifier which is shared with relatively few individuals). For example, if the physical address includes a street address of “10 Main Street”, then the unit identifiers could optionally be indicated as “10 Main Street, Unit 1”, “10 Main Street, Unit 2”, and the like, or “10 Main Street, Unit A”, or any other identifier. Of course any word or alphanumeric string or number could optionally be provided in place of “unit” and/or in place of the complete unit identifier. The virtual US billing address also preferably includes at least a zip code which is consistent with the street and town address.

The virtual US billing address may optionally be provided by the payment module as described in some embodiments of the present invention herein, and/or by any other suitable component of the system.

In stage 3, if the financial instrument is a physical object or preferably for any type of financial instrument, the recipient also provides a real physical address. For later transactions, the physical address may optionally be checked against the virtual US address for verification. Also the physical address is preferably verified as part of the anti-fraud examinations which are performed as previously described.

In stage 4, the recipient may optionally use the virtual US address, or at least preferably the zip code of the virtual US address, as an identifier for transactions with the financial instrument as required. For example, if an on-line to merchant requires provision of a zip code for the AVS system, then the recipient preferably uses the virtual US address zip code. The paying party may also optionally require use of the AVS system for verification of identity of the recipient before funds are provided to the financial instrument and/or before the financial instrument itself is provided.

According to preferred embodiments of the present invention, the use of the virtual US address is preferably tied to the particular financial instrument, which may optionally have one or more limitations placed upon it in order to reduce the risk of fraud and/or money laundering.

While the invention has been described with respect to a limited number of embodiments, it will be appreciated that many variations, modifications and other applications of the invention may be made.

What is claimed is:

1. A method for determining risk of payment associated with a paying party and with a recipient party through a computer system, the method comprising:
Receiving identification information from the paying party and from the recipient party, wherein said identification information at least comprises a physical address of each of the paying party and of the recipient party;
Performing an anti-fraud process to identify each of the paying party and of the recipient party for said financial transaction, said anti-fraud process including at least an analysis of said physical address and prescreening according to a history of one or more interactions with each of the paying party and of the recipient party with the computer system, including a background review of each of the paying party and the recipient party;
determining whether a payment is to be made or said payment is to be rejected according to at least a combination of identification of said recipient party according to said anti-fraud process and an identification of said paying party, and a geographical location of said recipient party by a payment computer system;
selecting a payment mechanism for providing said payment to said recipient party according to at least said combination of identification of said recipient party and an identification of said paying party and a geographical location of said recipient party by a payment computer system;
communicating an amount to be paid to said recipient party from the payment computer system to a computer system of a third party payment service; and
paying said amount by said third party payment service according to said payment mechanism.

2. The method of claim 1, wherein said analyzing said physical address further comprises: Providing a virtual address for each of the paying party and of the recipient party for performing a financial transaction as an identifier for each of the paying party and the recipient party; and
Correlating said virtual address and said physical address to identify each of the paying party and of the recipient party for said financial transaction.

3. The method of claim 1, wherein said performing said anti-fraud process further comprises determining a risk of payment from said paying party.

4. The method of claim 3, wherein said performing said anti-fraud process further comprises determining a risk of paying said recipient party.

5. The method of claim 4, wherein said communicating said amount from the payment computer system to a computer system of a third party payment service comprises selecting a third party payment mechanism according to said risk.

6. The method of claim 5, wherein said communicating further comprises charging a higher fee for said payment according to said risk.

7. The method of claim 5, wherein said selecting said payment mechanism further comprises placing one or more limitations on said payment mechanism in order to reduce the risk of fraud, money laundering or a combination thereof.

8. The method of claim 1, further comprising calculating an amount to be paid for one or more goods or services, or a combination thereof, to said recipient party by said paying party.

9. The method of claim 8, wherein said goods or services, or a combination thereof, comprise one or more intangible goods or services.

10. The method of claim 9, wherein said goods or services, or a combination thereof, comprise content.

11. The method of claim 10, wherein said content is provided through an electronic medium.

12. The method of claim 11, wherein said electronic medium comprises the Internet.

13. The method of claim 12, wherein said content comprises one or more of video, audio, written material (optionally with or without illustrations), images and mixed content, software, games or Web page views.

14. The method of claim 13, wherein said calculating payment is performed according to one or more of page views, downloads or displays of the content.

15. The method of claim 14, wherein said calculating payment is performed according to revenue from one or more advertisements associated with said one or more of page views, downloads or displays of the content.

16. The method of claim 1, further comprising providing funds for payment by a paying party, wherein said paying the recipient party further comprises placing at least one restriction on use of said funds, wherein said placing said at least one restriction is performed according to said selected payment mechanism.

17. The method of claim 16, wherein said paying party is a parent of said recipient party.

18. The method of claim 4, wherein said selected said payment mechanism comprises: providing an option of expedited payment; and if accepted, charging a fee for said expedited payment according to a calculated credit risk.

19. The method of claim 4, wherein said selecting said payment mechanism comprises: performing a fraud risk assessment of at least the recipient party before the expedited payment option is offered; providing an option of expedited payment before payment is received from said paying party; and if accepted, paying said recipient party before payment is received from said paying party.

20. The method of claim 1, wherein said identification information further comprises a profile of the recipient party, paying party or a combination thereof.

21. The method of claim 20, wherein said profile comprises a payment history of the recipient party, paying party or a combination thereof.

22. The method of claim 20, wherein said profile comprises information received from said recipient party.

23. The method of claim 22, further comprising before said paying said amount: receiving information about said recipient from said paying party; and cross-checking said information with information received from said recipient.

24. The method of claim 1, further comprising providing funds for payment by a paying party, wherein said paying the recipient party further comprises placing at least one restriction on use of said funds, wherein said placing at least one restriction on use of said funds by said paying party comprises placing said at least one restriction according to an age of the recipient.

25. The method of claim 24, wherein said placing at least one restriction comprises restricting use of said funds to block purchase of a category of products.

26. The method of claim 24, wherein said placing at least one restriction comprises restricting use of said funds to only permit purchase of a category of products.

27. The method of claim 24, wherein said selecting said payment mechanism comprises selecting said payment mechanism from the group consisting of a physical card, a virtual card, a debit card, a bank account, electronic gift certificate, a physical payment certificate and electronic funds transfer.

28. The method of claim 8, wherein calculating said amount to be paid further comprises receiving information about a plurality of micro-payments to be made to the recipient party; and calculating a total amount to be paid according to said micropayments.

29. The method of claim 1, wherein said geographical location of said recipient party comprises a mailing address, the method further comprising confirming said mailing address before said paying said amount.

30. The method of claim 29, wherein said confirming said mailing address further comprises mailing an item of mail to said mailing address.

31. The method of claim 29, the method further comprising providing said mailing address by said recipient party to access said payment.

32. The method of claim 1, wherein said recipient party comprises a plurality of recipient parties and wherein said paying said amount further comprises splitting said amount between said plurality of recipient parties.

33. The method of claim 1, further comprising disclosing details of said payment mechanism to said recipient party and to said paying party.
